(19) United States
(12) Patent Application Publication
(10) Pub. No.: US 2026/0070629 A1
(43) Pub. Date: Mar. 12, 2026

(54) ELECTRIC ASSISTED BICYCLE

(71) Applicant: Yamaha Hatsudoki Kabushiki Kaisha, Shizuoka (JP)

(72) Inventor: Tatsuya NAMBA, Shizuoka (JP)

(21) Appl. No.: 19/321,101

(22) Filed: Sep. 5, 2025

(30) Foreign Application Priority Data
Sep. 10, 2024 (JP) 2024-156883

(51) Int. Cl. B62M 6/55; B62J 43/13; B62K 3/02; B62M 6/90; B62M 9/16

(52) U.S. Cl. CPC B62M 6/55; B62J 43/13; B62K 3/02; B62M 6/90; B62M 9/16

(57) ABSTRACT

A first sprocket 54L is disposed on a left side of a bottom bracket 51 and configured to rotate integrally with a crankshaft 52. A second sprocket 54R is disposed on a right side of the bottom bracket 51 and configured to rotate integrally with the crankshaft 52. A first chain 56L is wound around an outer periphery of a third sprocket 23a provided to a motor output shaft 23 and an outer periphery of a first sprocket 54L and transmits torque from the third sprocket 23a to the first sprocket 54L. A second chain 56R is wound around an outer periphery of a fourth sprocket 55a provided to an axle 12a of a rear wheel 12 and an outer periphery of a second sprocket 54R and transmits torque from the second sprocket 54R to the fourth sprocket 55a.

### CROSS-REFERENCE TO RELATED APPLICATION

The present application claims priority from Japanese application No. 2024-156883 filed on Sep. 10, 2024, the content of which is hereby incorporated by reference into this application.

### BACKGROUND OF THE INVENTION

### 1. Field of the Invention

The present disclosure relates to an electric assisted bicycle.

### 2. Description of the Related Art

Electric assisted bicycles are used to drive on rough terrain, such as mountain roads and rough roads. The electric assisted bicycle of U.S. patent application publication No. 2022/0289335 (patent document 1) includes the frame having the down member extending diagonally downward from the head pipe to the crankshaft. The motor unit is supported between the lower end of the down member and the crankshaft.

Patent document 1 describes the sprocket provided on the crankshaft and the sprocket provided on the output shaft of the motor unit being engaged in the single chain. As such, there is a problem of limited flexibility in the layout of the motor unit. As the flexibility in the layout of the motor unit is limited, the flexibility in the layout of parts other than the motor unit (e.g., battery) also becomes limited.

When riding a bicycle on rough terrain, sometimes the posture of the bicycle may need to be changed. It is important that the moment of inertia of the bicycle is not too large to facilitate changes in the posture of the bicycle by the rider, that is, to improve the operability of the bicycle. However, if the flexibility in the layout of components, such as a motor unit and a battery, is limited, such a structure of the bicycle for improving the operability may be difficult to achieve.

### SUMMARY OF THE INVENTION

(1) An electric assisted bicycle proposed in the present disclosure includes a crankshaft, a bottom bracket that supports the crankshaft, and a motor unit separated from the bottom bracket. The motor unit includes an electric motor, a housing that houses the electric motor, and a motor output shaft that outputs torque of the electric motor. The electric assist bicycle includes a first rotating member that is disposed on one of a right side or a left side of the bottom bracket and configured to integrally rotate with the crankshaft, a second rotating member that is disposed on the other one of the right side or the left side of the bottom bracket and configured to integrally rotate with the crankshaft, a third rotating member that is provided to the motor output shaft, a first annular transmission member that is wound around an outer periphery of the first rotating member and an outer periphery of the third rotating member and transmits torque from the third rotating member to the first rotating member, a fourth rotating member that is provided to an axle of a rear wheel, and a second annular transmission member that is wound around an outer periphery of the second rotating member and an outer periphery of the fourth rotating member and transmits torque from the second rotating member to the fourth rotating member.

In the electric assisted bicycle described above, the torque of the motor unit is transmitted to the crankshaft through the first annular transmission member, and the torque of the crankshaft is transmitted to an axle of a rear wheel through the second annular transmission member. As such, for example, the flexibility in the position of the motor unit can be increased compared to the conventional structure in which the torque of the motor unit is directly transmitted to the second annular transmission member. The first annular transmission member is disposed on one of the right side or the left side of the bottom bracket, and the second annular transmission member is disposed on the other one of the right side or the left side of the bottom bracket, and thus interference between the first annular transmission member and the second annular transmission member can be easily avoided.

In the electric assisted bicycle of (1), the first and second annular transmission members may be chains or belts, for example.
(2) In a plan view of the electric assisted bicycle according to (1), at least a part of the motor unit is positioned between the first rotating member and the second rotating member. In this structure, the motor unit can be positioned closer to the crankshaft. If the motor unit is positioned closer to the crankshaft, the moment of inertia around the crankshaft can be reduced and the operability of the bicycle can be improved.
(3) In a side view of the electric assisted bicycle according to (2), a part of the motor unit overlaps at least one of the first rotating member or the second rotating member. In this structure, the position of the motor unit is close to the crankshaft. This serves to reduce the moment of inertia around the crankshaft and improve the operability of the bicycle.
(4) The electric assisted bicycle according to any one of (1) to (3) further includes a body frame that includes a head pipe supporting a steering shaft, a down frame portion extending diagonally backward and downward from the head pipe, and a frame bottom supporting the bottom bracket.
(5) In the electric assisted bicycle according to (4), the motor unit is disposed above the frame bottom. Such a layout facilitates securing a space in front of the frame bottom. This space can be used to dispose other components (e.g. battery).
(6) In the electric assisted bicycle according to (4) or (5), the motor unit is disposed behind the down frame portion. In such a layout, the motor unit can be protected by the down frame portion.
(7) In the electric assisted bicycle according to any one of (4) to (6), the body frame includes a seat frame portion that is positioned behind the down frame portion, the motor unit is disposed behind the seat frame portion, and a battery is attached to the down frame portion. Such a layout facilitates securing a space in front of the frame bottom. This space can be used to dispose a battery.
(8) In the electric assisted bicycle according to any one of (4) to (7), a recess is formed in the body frame, and a part of the motor unit is disposed in the recess. This structure can further increase the flexibility in the position of the motor unit.
(9) In the electric assisted bicycle according to (8), the motor unit is disposed below the body frame, and the recess that opens downward is formed in the body frame. This structure prevents the motor unit from being positioned excessively low.
(10) In the electric assisted bicycle according to any one of (1) to (9), the motor unit is positioned in front of the bottom bracket, and one of a central shaft of the electric motor and the motor output shaft is located in a front-rear direction from the other of the central shaft of the electric motor and the motor output shaft. Such an arrangement of the motor unit can prevent, for example, the center of gravity of the motor unit from being excessively low.
(11) In the electric assisted bicycle according to any one of (1) to (9), the motor unit is disposed above the bottom bracket, and a central shaft of the electric motor is positioned lower than the motor output shaft. With this arrangement, the center of gravity of the motor unit can be lowered and positioned closer to the crankshaft compared to a case in which the central shaft of the electric motor is positioned higher than the motor output shaft, for example.
(12) The electric assisted bicycle according to claim (4) further includes a battery that supplies a current to the motor unit, and the battery is disposed in a front side of the down frame portion. With the arrangement of (12), the relatively large space in front of the down frame portion can be used to easily dispose a battery with a large capacity. For example, an elongate battery may be disposed in the extending direction of the down frame portion.
(13) In the electric assisted bicycle according to (12), a lower end of the battery is positioned lower than an upper end of at least one of the first rotating member or the second rotating member. Such an arrangement serves to lower the center of gravity of the battery.
(14) In the electric assisted bicycle according to (12), the lower end of the battery is positioned lower than the motor unit. Such an arrangement serves to lower the center of gravity of the battery.
(15) The electric assisted bicycle according to any one of (1) to (14) further includes a tensioner that pushes a part of the first annular transmission member toward an outside or an inside of the first annular transmission member. Such a structure can reduce the shaking of the first annular transmission member while the bicycle is traveling, and prevent disengagement between the first annular transmission member, and the first and third rotating members.
(16) The electric assisted bicycle according to (15) further includes a body frame that includes a head pipe supporting a steering shaft, a down frame portion extending diagonally backward and downward from the head pipe, and a frame bottom supporting the bottom bracket. The tensioner is supported by the body frame. Such a structure serves to easily select the position of the tensioner.
(17) In the electric assisted bicycle according to (15), the tensioner is supported by the housing of the electric motor.

### BRIEF DESCRIPTION OF THE DRAWINGS

FIG. 1 is a right side view of an electric assisted bicycle according to a first example proposed in the present disclosure;

FIG. 2 is a right side view of the electric assisted bicycle shown in FIG. 1, illustrating main components thereof;

FIG. 3A is a left side view of the main components shown in FIG. 2;

FIG. 3B is a left side view of the main components shown in FIG. 3A with a cover removed;

FIG. 4 is a perspective view of a body frame;

FIG. 5 is a left side view of a motor unit and a bottom bracket showing a positional relationship therebetween;

FIG. 6 is a cross-sectional view of the components taken along the line VI-VI in FIG. 3B;

FIG. 7 is a right side view of the electric assisted bicycle according to a second example, illustrating main components thereof;

FIG. 8 is a left side view of the electric assisted bicycle shown in FIG. 7, illustrating main components thereof;

FIG. 9 is a cross-sectional view of the components taken along the line IX-IX in FIG. 8;

FIG. 10 is a right side view of the electric assisted bicycle according to a third example, illustrating main components thereof;

FIG. 11 is a left side view of the electric assisted bicycle shown in FIG. 10, illustrating main components thereof;

FIG. 12 is a perspective view of the body frame of the electric assisted bicycle shown in FIG. 10, and

FIG. 13 is a cross-sectional view of the components taken along the line XIII-XIII in FIG. 11.

### DETAILED DESCRIPTION OF THE INVENTION

The present disclosure is to be considered as an exemplification of the invention, and is not intended to limit the invention to the specific embodiments illustrated by the figures or description below. The present invention will now be described by referencing the appended figures representing embodiments.

The terminology used herein is for the purpose of describing particular embodiments only and is not intended to be limiting of the invention. As used herein, the term “and/or” includes any and all combinations of one or more of the associated listed items. As used herein, the singular forms “a,” “an,” and “the” are intended to include the plural forms as well as the singular forms, unless the context clearly indicates otherwise. It will be further understood that the terms “comprises”, “comprising”, “includes”, and/or “including”, when used in this specification, specify the presence of stated features, steps, operations, elements, and/or components, but do not preclude the presence or addition of one or more other features, steps, operations, elements, components, and/or groups thereof.

Unless otherwise defined, all terms (including technical and scientific terms) used herein have the same meaning as commonly understood by one having ordinary skill in the art to which this invention belongs. It will be further understood that terms, such as those defined in commonly used dictionaries, should be interpreted as having a meaning that is consistent with their meaning in the context of the relevant art and the present disclosure and will not be interpreted in an idealized or overly formal sense unless expressly so defined herein.

In describing the invention, it will be understood that a number of technologies are disclosed. Each of these has individual benefit and each can also be used in conjunction with one or more, or in some cases all, of the other disclosed technologies. Accordingly, for the sake of clarity, this description will refrain from repeating every possible combination of the individual technologies in an unnecessary fashion. Nevertheless, the specification and claims should be read with the understanding that such combinations are entirely within the scope of the invention and the claims.

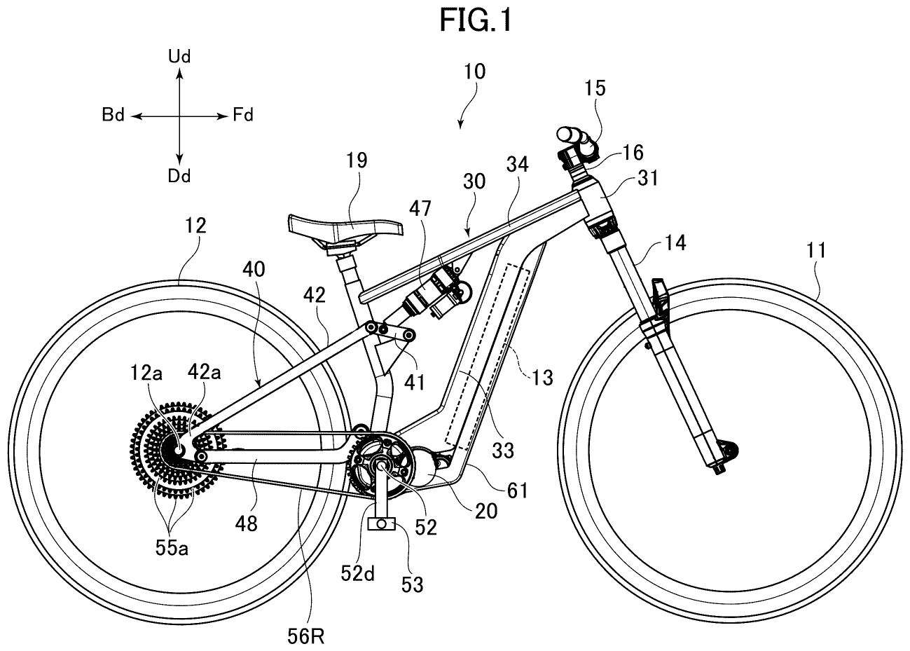

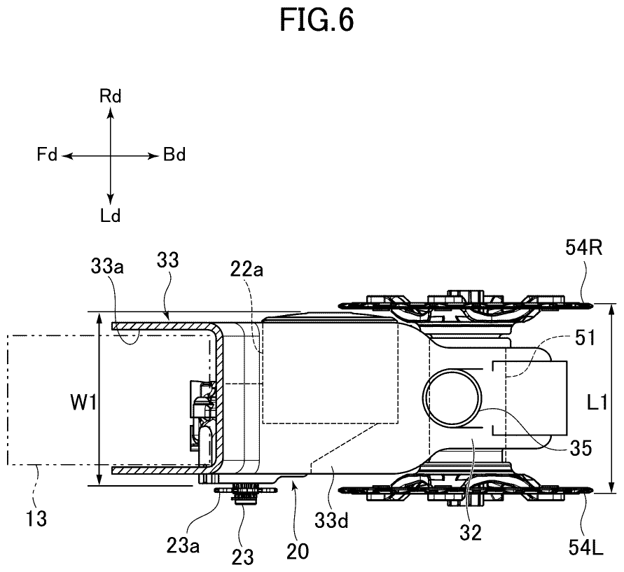

An electric assisted bicycle proposed in the present disclosure will be described. In the description below, Fd and Bd directions shown in the drawings such as FIG. 1 are referred to as a forward direction and a backward direction, respectively. Ud and Dd directions shown in the drawings such as FIG. 1 are referred to as an upward direction and a downward direction, respectively. Further, Ld and Rd directions shown in FIG. 6 are referred to as a left direction and a right direction, respectively.

In the following description, for purposes of explanation, numerous specific details are set forth in order to provide a thorough understanding of the present invention. It will be evident, however, to one skilled in the art that the present invention may be practiced without these specific details.

### First Example of Electric Assisted Bicycle

An electric assisted bicycle 10 shown in FIG. 1, for example, will be described as a first example of the electric assisted bicycle proposed in the present disclosure.

As shown in FIG. 1, the electric assisted bicycle 10 includes a motor unit 20, a battery 13, a body frame 30, and a seat 19.

As shown in FIG. 1, the body frame 30 includes a head pipe 31 supporting a steering shaft 16 at the frontmost part thereof. A steering handle 15 is fixed to the upper part of the steering shaft 16. The steering handle 15 has grips 15a on the right and left parts thereof. A front fork 14 is fixed to the lower part of the head pipe 31. A front wheel 11 is supported by the lower end of the front fork 14.

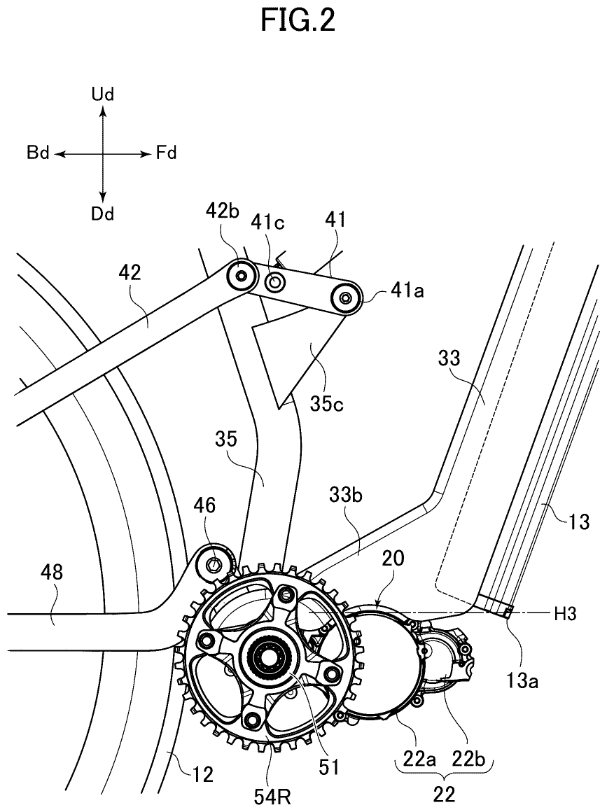

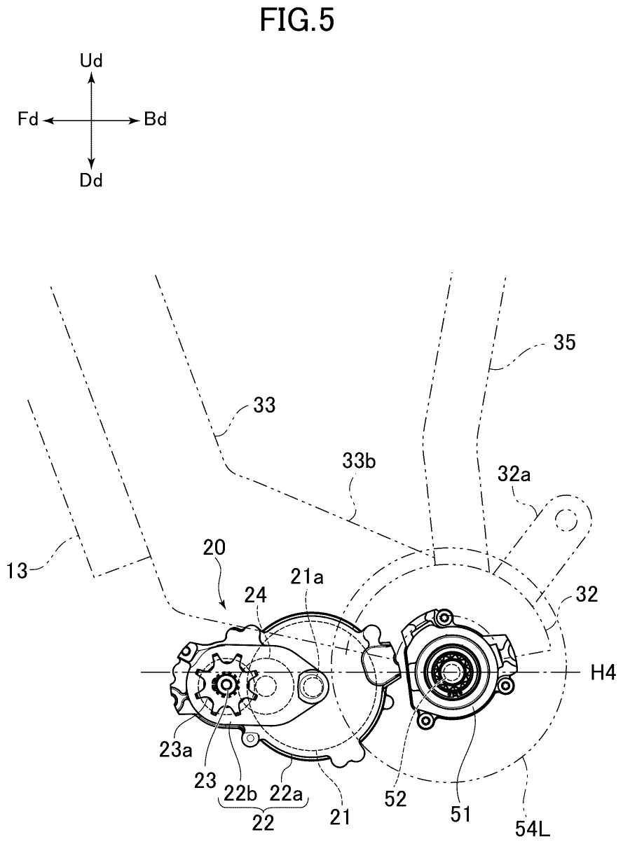

The bicycle 10 includes a bottom bracket 51 (see FIGS. 2, 5) that rotatably supports a crankshaft 52 (see FIG. 1). The bottom bracket 51 is substantially cylindrical, and the crankshaft 52 (see FIG. 1) is inserted therein. The crankshaft 52 includes crank arms 52d at the right and left ends thereof. Pedals 53 are fixed to the ends of the crank arms 52d.

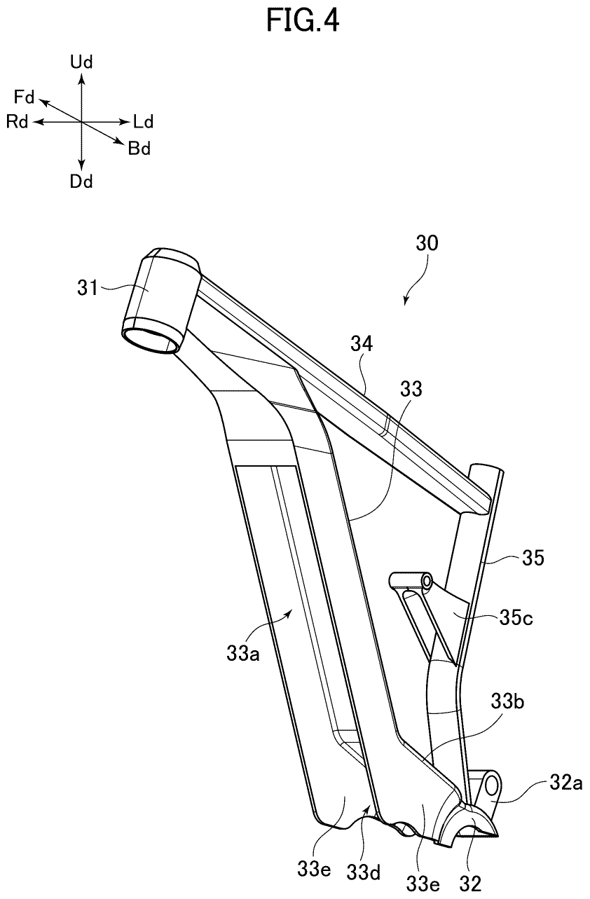

As shown in FIG. 4, the body frame 30 includes a frame bottom 32 to which the bottom bracket 51 is attached. The frame bottom 32 is positioned at the lower end of the body frame 30. The bottom bracket 51 is disposed on the lower part of the frame bottom 32, for example. The bottom bracket 51 is fixed to the lower part of the frame bottom 32 by a fastener, such as a bolt and a screw. The bottom bracket 51 may be welded to the frame bottom 32.

As shown in FIG. 4, the body frame 30 includes a down frame portion 33 extending diagonally backward and downward from the head pipe 31 to the frame bottom 32. The lower end (rear end) of the down frame portion 33 is connected to the frame bottom 32. As shown in FIG. 4, the lower end (rear end) of the down frame portion 33 is connected to the front side of the frame bottom 32, for example. The positional relationship between the lower end (rear end) of the down frame portion 33 and the frame bottom 32 is not limited to the example as illustrated. For example, the frame bottom 32 (portion supporting the bottom bracket 51) may be positioned below the lower end (rear end) of the down frame bottom 33.

A seat frame portion 35 is connected to a lowermost part 33b of the down frame portion 33. The seat frame portion 35 is also connected to the frame bottom 32. In this manner, the seat frame portion may be connected to both the lowermost part 33b of the down frame portion 33 and the frame bottom 32 or may be connected to only one of these portions.

As will be described later, the motor unit 20 is supported by the lowermost part 33b of the down frame portion 33. The frame bottom 32 supporting the bottom bracket 51 and the lowermost part 33b of the down frame portion 33 may be integrally formed. The lowermost part 33b may be connected to the portion of the down frame portion 33 extending diagonally downward by welding, for example.

As shown in FIG. 4, the body frame 30 includes a main frame portion 34 extending from the head pipe 31 rearward. The main frame portion 34 is positioned above the down frame portion 33. The body frame 30 includes a seat frame portion 35 extending downward from the rear end of the main frame portion 34. The lower end of the seat frame portion 35 is fixed to the frame bottom 32. The lower end of the seat frame portion 35 is fixed to the upper side of the frame bottom 32, for example.

The structure of the body frame 30 is not limited to the example illustrated in FIG. 4. For example, the down frame portion 33 or the seat frame portion 35 may be integrally formed with the frame bottom 32 (portion supporting the bottom bracket 51). The main frame portion 34 and the seat frame portion 35 may also be integrally formed. For example, the rear part of the main frame portion 34 may be curved and extend downward, and the lower end thereof may be fixed to the frame bottom 32.

The frame bottom 32 may be formed in a tubular shape. The bottom bracket 51 may be fitted into the tubular frame bottom 32 to be fixed to the frame bottom 32. The lower end of the seat frame portion 35 may be fixed to the outer peripheral surface of the frame bottom portion 32, or the lower end (rear end) of the down frame portion 33 may be connected to the outer peripheral surface of the frame bottom portion 32.

As shown in FIG. 1, the bicycle 10 includes a rear arm 48. The front end of the rear arm 48 is coupled to the body frame 30 via a pivot shaft. For example, a support portion 32a (see FIG. 4) protruding backward and upward is formed in the rear part of the frame bottom 32. The front end of the rear arm 48 is coupled to the support portion 32a via the pivot shaft 46, for example. The rear arm 48 is movable upward and downward about the pivot shaft 46. The rearmost part of the rear arm 48 is coupled to a rear end part 42a of a second link member 42 to be described later.

As shown in FIG. 1, the bicycle 10 includes a rear cushion 47 and a link mechanism 40 that couples the rear cushion 47 to the rear arm 48. The rear cushion 47 is disposed below the rear part of the main frame portion 34, for example. More specifically, the rear cushion 47 is disposed between the seat frame portion 35 and the down frame portion 33 and below the rear part of the main frame portion 34. The upper end of the rear cushion 47 is attached to the main frame portion 34 via the bracket. The link mechanism 40 is coupled to the rear end of the rear cushion 47.

As shown in FIG. 1, the link mechanism 40 includes a first link member 41 and a second link member 42, for example. When the bicycle 10 travels on uneven roads, the impact acting on the rear wheel 12 is transmitted to the rear cushion 47 through the link members 42 and 41.

As shown in FIG. 2, a frontmost part 41a of the first link member 41 is coupled via the shaft to the bracket 35c extending from the seat frame portion 35. The rear end part of the first link member 41 is coupled to a front end part 42b of the second link member 42 via the shaft. The second link member 42 extends from the front end part diagonally backward and downward. As shown in FIG. 1, an axle 12a of the rear wheel 12 is supported by a rear end part 42a of the second link member 42. The rear end part of the rear arm 48 is coupled to the rear end part 42a of the second link member 42 via the shaft. The rear end of the rear cushion 47 is coupled to a middle part 41c (see FIG. 2) of the first link member 41 via the shaft.

The bicycle 10 may not include the rear cushion 47 and the link mechanism 40. In this case, the axle 12a of the rear wheel 12 may be supported by another member (stay) extending from the seat frame portion 35.

### Right Sprocket and Chain

As shown in FIGS. 1 and 2, the bicycle 10 includes a sprocket 54R (“second rotating member” in the claims) disposed on the right side of the bottom bracket 51. The sprocket 54R is mounted on the crankshaft 52 and rotates integrally with the crankshaft 52.

As shown in FIG. 1, sprockets 55a (“fourth rotating member” in the claims) are also provided on the axle 12a of the rear wheel 12. A plurality of sprockets 55a having different numbers of teeth are provided on the axle 12a. These sprockets form a transmission. A chain 56R (“second annular transmission member” in the claims) is wound around the outer periphery of the selected one of the sprockets 55a and the outer periphery of the sprocket 54R of the crankshaft 52. The torque of the crankshaft 52 is transmitted to the rear wheel 12 through the sprocket 54R, the chain 56R, and the sprocket 55a.

The bicycle 10 includes a chain derailleur (not shown) on the rear wheel 12. The chain derailleur winds the chain 56R around one of the sprockets 55a corresponding to the change operation of the rider, among the plurality of sprockets 55a. The change operation is performed on a lever and a button provided on the steering handle 15, for example.

The number of sprockets 55a provided on the rear wheel 12 of the bicycle 10 may be one. In other words, the structure proposed in the present disclosure may be applied to a bicycle in which only one sprocket 55a is provided on the rear wheel 12.

### Motor Unit

As shown in FIG. 5, the motor unit 20 includes an electric motor 21, a housing 22 containing the electric motor 21, and a motor output shaft 23 for outputting torque of the electric motor 21. The motor output shaft 23 protrudes to the left from the housing 22. A sprocket 23a (“third rotating member” in the claims) is attached to the motor output shaft 23. The motor unit 20 may contain a reduction mechanism 24 having a plurality of gears. The rotation of the electric motor 21 may be transmitted to the motor output shaft 23 through the reduction mechanism 24.

As shown in FIG. 5, the bottom bracket 51 and the motor unit 20 are separated from each other. That is, the bottom bracket 51 is not a component contained in the housing 22. In the example shown in FIG. 5, for example, the motor unit 20 is separated forward from the bottom bracket 51.

### Left Sprocket and Chain

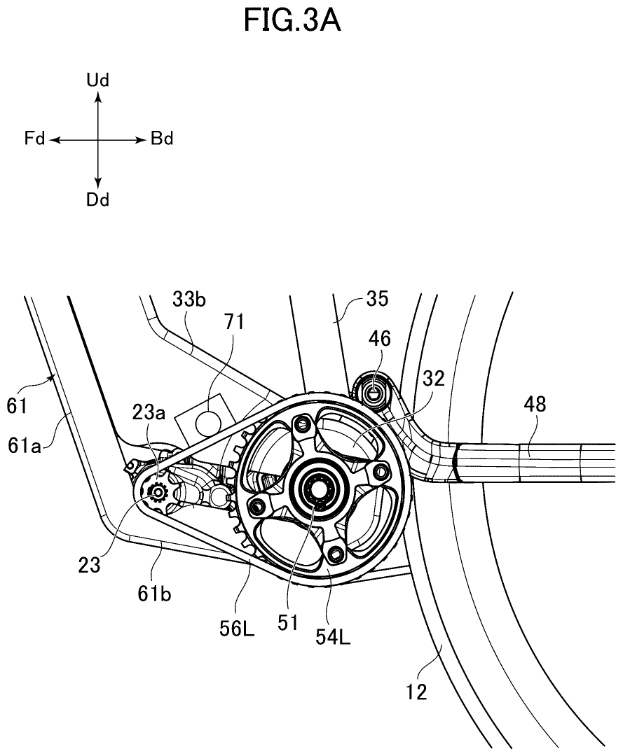

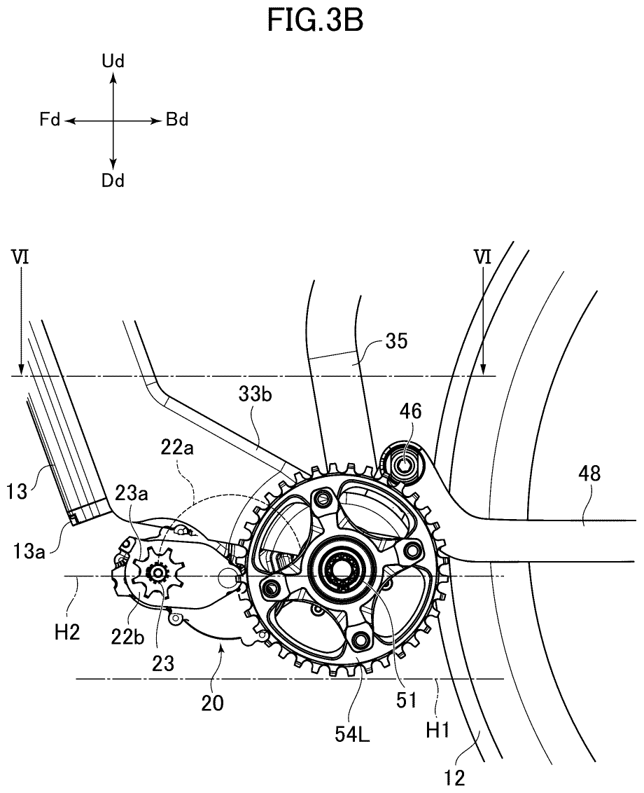

As shown in FIGS. 3A and 3B, the bicycle 10 includes a sprocket 54L (“first rotating member” in the claims) disposed on the left side of the bottom bracket 51. The sprocket 54L is mounted on the crankshaft 52 and rotates integrally with the crankshaft 52. A sprocket 23a is also fixed to the motor output shaft 23 of the motor unit 20. A chain 56L (see FIG. 3A, “first annular transmission member” in the claims) is wound around the outer periphery of the sprocket 23a of the motor output shaft 23 and the outer periphery of the sprocket 54L of the crankshaft 52.

The torque of the motor unit 20 is transmitted to the crankshaft 52 (see FIG. 1) through the sprocket 23a of the crankshaft 23, the chain 56L, and the sprocket 54L. The torque of the motor unit 20 thus transmitted to the crankshaft 52 is transmitted to the rear wheel 12 through the sprocket 54R and the chain 56R on the right side of the bottom bracket 51 as described above.

The bottom bracket 51 and the motor unit 20 are separated from each other in the bicycle 10. As such, the flexibility in the layout of the motor unit 20 can be increased compared to the conventional structure in which these components are unitized.

The torque is transmitted from the crankshaft 52 to the rear wheels 12 by the sprocket 54R and the chain 56R disposed on the right side of the bicycle 10. In contrast, the torque is transmitted from the motor unit 20 to the crankshaft 52 by the chain 56L and the sprocket 54L disposed on the left side of the bicycle 10. This structure further improves the flexibility in the layout of the motor unit 20. For example, the layout of the motor unit 20 is limited due to the position of the chain 56R in the structure in which the sprocket 23a of the motor unit 20 is directly engaged to the right chain 56R. Such layout restrictions can be eliminated in the bicycle 10.

In a structure in which both of the two sprockets 54R and 54L are disposed only on the right side (or the left side) of the bicycle 10, some measures need to be taken to avoid interference between the two chains 56R and 56L, such as disposing the two sprockets 54R and 54L apart from each other in the vehicle width direction (in the axial direction of the crankshaft 52). Such a measure affects not only the position of the sprockets 54R and 54L but also the layout of other components. In this regard, in the present embodiment, one of the sprockets 54R and 54L is disposed on the right side of the bicycle 10 and the other is disposed on the left side in the bicycle 10, and thus interference of the chains 56R and 56L does not occur. The distance from the center of the bicycle 10 in the vehicle width direction (the center of the front wheel 11 or the rear wheel 12 in the left and right direction) to the sprocket 54R may be the same as the distance from the center of the bicycle 10 in the vehicle width direction to the sprocket 54L. The sprocket 54L and the sprocket 23a of the motor unit 20 are positioned in a common vertical plane.

Typically, users stand on the left side of the bicycle when walking while pushing the bicycle. As such, the chain is generally disposed on the right side of the bicycle. If such a structure is employed in the bicycle 10 and both chains 56R and 56L are disposed on the right side of the bicycle 10, the sprockets 54R and 54L and the chains 56R and 56L protrude excessively to the right side. Such a problem, however, can be avoided in the bicycle 10.

In the bicycle 10, the number of teeth of the sprocket 23a provided on the motor output shaft 23 is less than the number of teeth of the sprocket 54L provided on the crankshaft 52. As such, the rotation of the motor output shaft 23 is reduced and transmitted to the crankshaft 52.

In the example shown in FIGS. 2 to 3B, the sizes (radii) of the left sprocket 54L and the right sprocket 54R are substantially the same. This serves to prevent the reduction in the minimum ground clearance (the distance from the ground to the bottom end of the sprocket) that is caused by one of the sprockets being larger in size.

However, unlike the example shown in FIG. 2, for example, the sizes of the sprockets 54R and 54L may differ. For example, the size of the left sprocket 54L, which transmits the torque of the motor unit 20 to the crankshaft 52, may be larger than the size of the right sprocket 54R. This ensures a large reduction ratio. In contrast, the size of the left sprocket 54L, which transmits the torque of the motor unit 20 to the crankshaft 52, may be smaller than the size of the right sprocket 54R.

### Control of Electric Motor

The battery 13 (see FIG. 1) is electrically connected to the electric motor 21. The electric motor 21 is driven by the current of the battery 13. The bicycle 10 includes a torque sensor (not shown) for detecting a torque acting on the crankshaft 52 (pedal force acting on the pedal 53) and a vehicle speed sensor (not shown) for detecting a vehicle speed. The bicycle 10 includes a control device (not shown) that includes a microprocessor and a power semiconductor and controls the current supplied from the battery 13 to the electric motor 21 based on the outputs of the torque sensor and the vehicle speed sensor. The torque sensor is provided on the crankshaft 52, for example. The vehicle speed sensor is provided on the front wheel 11 or the rear wheel 12.

The control device calculates an assist ratio based on the output of the vehicle speed sensor and calculates a command value of the current based on the assist ratio and the output of the torque sensor. The drive unit supplies a current corresponding to the command value to the electric motor 21.

### Layout of Motor Unit

As shown in FIG. 5, the motor unit 20 is disposed in front of the bottom bracket 51. The motor unit 20 is disposed such that a central shaft 21a of the electric motor 21 and the motor output shaft 23 are substantially parallel to the crankshaft 52. One of the central shaft 21a of the electric motor 21 and the motor output shaft 23 is located in the front-rear direction from the other one of the central shaft 21a of the electric motor 21 and the motor output shaft 23. In other words, a horizontal line H2 (see FIG. 3B, a line parallel to the ground) intersects both of the central shaft 21a of the electric motor 21 and the motor output shaft 23.

Such an arrangement of the motor unit 20 prevents the lower end of the motor unit 20 from being positioned excessively low. As shown in FIG. 3B, the entire motor unit 20 is positioned above a horizontal line H1 passing through the lower end of the sprocket 54L. This prevents the minimum ground clearance (the distance from the ground) of the bicycle 10 from being reduced due to the motor unit 20. Further, the center of gravity of the motor unit 20 can be lowered compared to a layout in which the position of the electric motor 21 is higher than that of the motor output shaft 23, for example.

As shown in FIG. 5, the motor unit 20 is disposed in front of the bottom bracket 51, for example. A horizontal line H4 passing through the center of the crankshaft 52 intersects the motor unit 20. More specifically, the horizontal line H4 intersects the electric motor 21 and also intersects the sprocket 23a provided on the motor output shaft 23. This serves to reduce the difference in height (distance from the ground) between the crankshaft 52 and the motor unit 20.

The motor unit 20 is disposed below the body frame 30. More specifically, as shown in FIG. 3B, the motor unit 20 is positioned below the lowermost part 33b of the down frame portion 33, which is positioned in front of the frame bottom 32. The motor unit 20 is fixed to the lowermost part 33b of the body frame 30 by a fastener, such as a screw and a bolt. With such an arrangement of the motor unit 20, the distance between the bottom bracket 51 and the motor unit 20 can be reduced, and the moment of inertia around the crankshaft 52 can thereby be reduced.

As shown in FIG. 4, a recess 33d that opens downward may be formed at the lowermost part 33b of the down frame portion 33. The motor unit 20 may be partially contained in the recess 33d. For example, the upper part of a main body 22a of the motor unit 20 may be disposed in the recess 33d. The lowermost part 33b of the down frame portion 33 includes left and right side walls 33e (see FIG. 4). The upper part of the main body 22a is disposed between the left and right side walls 33e.

As described above, the motor unit 20 includes the housing 22. The main body 22a of the motor unit 20 is a substantially cylindrical part of the housing 22 containing the electric motor 21. The housing 22 may include a protruding portion 22b that protrudes from the main body 22a in the radial direction of the electric motor 21, housing the motor output shaft 23 and the reduction mechanism 24.

The down frame portion 33 having the recess 33d enables a structure in which the motor unit 20 is disposed below the body frame 30 while preventing the excessive low position of the motor unit 20. Further, the height of the bottom bracket 51 (distance from the ground) and the height of the motor unit 20 (distance from the ground) can be substantially aligned.

As will be described later, a recess 33a (see FIG. 4) that houses the battery 13 is formed on the front side of the down frame portion 33. The recess 33a opens forward and downward. The recess 33d that houses the motor unit 20 opens downward and forward. As shown in FIG. 4, the two recesses 33a and 33d may be continuous.

The bicycle 10 includes a cover 61 (see FIG. 1) that covers the front side of the battery 13. As shown in FIG. 3A, the cover 61 may cover the motor unit 20. That is, a front part 61a of the cover 61 may cover the front side of the battery 13, and a rear part 61b (lower part) of the cover 61 may cover the lower side of the motor unit 20. Unlike the example shown in FIG. 3A, the bicycle 10 may include a cover covering the lower side of the motor unit 20 separately from the cover covering the battery 13.

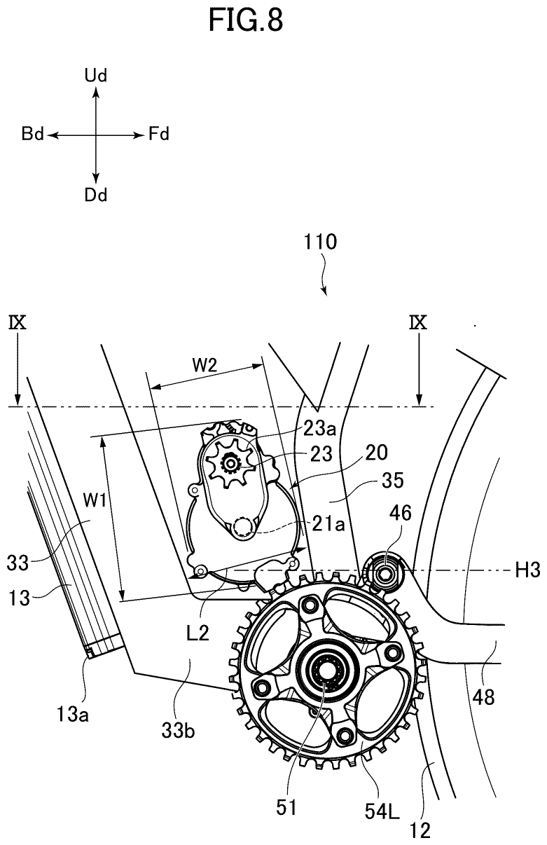

The arrangement of the motor unit 20 is not limited to the example shown in FIG. 3B. As shown in FIG. 8, for example, the motor unit 20 may be disposed above the lowermost part 33b of the down frame portion 33. In this case, the recess 33d may be formed on the upper side of the lowermost part 33b of the down frame portion 33. A part of the motor unit 20 may be housed in the recess 33d.

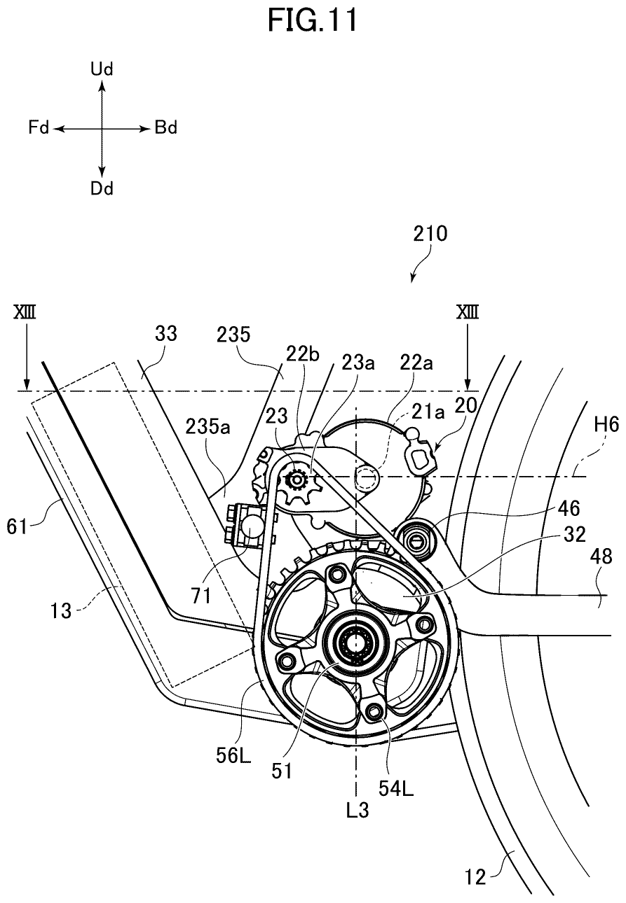

As yet another example, as shown in FIG. 11, the motor unit 20 may be disposed behind the seat frame portion 35 (which is labeled with reference numeral 235). In this case, a recess that opens rearward may be formed in the seat frame portion 35. A part of the motor unit 20 may be housed in such a recess. As described, the recess 33d may be formed in the body frame 30 and a part of the motor unit 20 may be disposed in the recess 33d.

As shown in FIG. 6, a size W1 of the motor unit 20 in the axial direction is smaller than a distance L1 between the right sprocket 54R and the left sprocket 54L provided on the crankshaft 52. The size W1 of the motor unit 20 in the axial direction is larger than the diameter of the seat frame portion 35. The size W1 is larger than the width of the bottom bracket 51.

As shown in FIG. 6, the motor unit 20 is disposed between the right sprocket 54R and the left sprocket 54L in the plane view of the bicycle 10. In this structure, the motor unit 20 can be positioned closer to the crankshaft 52. As such, the moment of inertia about the crankshaft 52 can be reduced, and the operability (posture change) of the bicycle 10 by the rider can be improved.

As shown in FIGS. 2 and 3B, a part of the motor unit 20 overlaps the left and right sprockets 54L and 54R in the side view of the bicycle 10. Such a layout of the motor unit 20 serves to reduce the distance between the motor unit 20 and the crankshaft 52. As a result, the moment of inertia around the crankshaft 52 can be reduced.

In the example shown in FIG. 3B, for example, the rear part of the main body 22a of the motor unit 20 overlaps the left and right sprockets 54L and 54R in the side view of the bicycle 10. On the other hand, the central shaft 21a (see FIG. 5) of the electric motor 21 is positioned on the outside (forward) of the outer peripheral edge of the sprockets 54R and 54L.

As stated above, the sizes of the two sprockets 54R and 54L may be different. In that case, a part of the motor unit 20 may overlap the smaller sprocket 54R or sprocket 54L in the side view of the bicycle 10.

The bicycle 10 may include a tensioner 71 pushing a part of the chain 56L toward the inside of the chain 56L or outside of the chain 56L. The tensioner 71 prevents the chain 56L from shaking when the bicycle 10 is traveling on rough terrain, for example, and from disengaging from the sprockets 54L and 23a due to such shaking.

As shown in FIG. 3A, the tensioner 71 is mounted on the body frame 30, for example. In the example shown in FIG. 3A, the tensioner 71 is fixed to the side wall 33e of the lowermost part 33b of the down frame potion 33. The tensioner 71 pushes a part of the chain 56L toward the inside of the chain 56L.

Unlike the example shown in FIG. 3A, the tensioner 71 may be supported by the housing 22 of the motor unit 20. For example, the tensioner 71 may be fixed to the side surface of the housing 22 by a fastener, such as a screw and a bolt.

### Battery Layout

As described above, the bicycle 10 includes the battery 13 that supplies power to the electric motor 21. The battery 13 is supported by the body frame 30. Specifically, as shown in FIG. 1, the battery 13 is supported by the down frame portion 33. The battery 13 is disposed in front of the down frame portion 33. Such an arrangement of the battery 13 serves to effectively use a space in front of the down frame portion 33 to dispose the battery 13.

The battery 13 has a box-like shape elongated in its extended direction (diagonally backward and downward). As shown in FIG. 4, the down frame portion 33 may include the recess 33a that opens forward on its front side. The battery 13 may be housed in the recess 33a. Such a structure of the down frame portion 33 serves to reduce the overhang of the battery 13, enabling the battery 13, which has a large capacity, to be used.

As shown in FIG. 4, the recess 33a housing the battery 13 is also opened forward and downward. Such a structure of the down frame portion 33 enables the use of the battery 13 having a large capacity.

The arrangement of the battery 13 is not limited to the example shown in FIG. 1. For example, the down frame portion 33 may have a cylindrical shape having an opening at the upper end or the lower end. In this case, the battery 13 may be inserted into the down frame portion 33 from the upper end or the lower end.

In another example, the battery 13 may be disposed behind the down frame portion 33. In this case, a recess opening backwards may be formed in the down frame portion 33, and the battery 13 may be housed in the recess. The battery 13 may be disposed behind the seat frame portion 35. In this case, a recess opening backwards may be formed in the seat frame portion 35, and the battery 13 may be housed in the recess.

As shown in FIG. 1, the bicycle 10 may include a cover 61 covering the front side of the battery 13. The cover 61 covers the entire battery 13 from the upper end to the lower end, for example. Alternatively, the cover 61 may cover only a part (e.g., the lower part) of the battery 13.

If the battery 13 is positioned closer to the crankshaft 52, the moment of inertia about the crankshaft 52 can be reduced. This arrangement facilitates the rider's operation (posture change) of the bicycle 10. As shown in FIGS. 2 and 3B, the position of the lower end 13a of the battery 13 is lower than the upper end of the sprockets 54R and 54L in the electric assisted bicycle 10. The position of the lower end 13a of the battery 13 is lower than a horizontal line H3 passing through the upper end of the motor unit 20. The motor unit 20 is positioned behind the lower end 13a of the battery 13.

### Second Example of Electric Assisted Bicycle

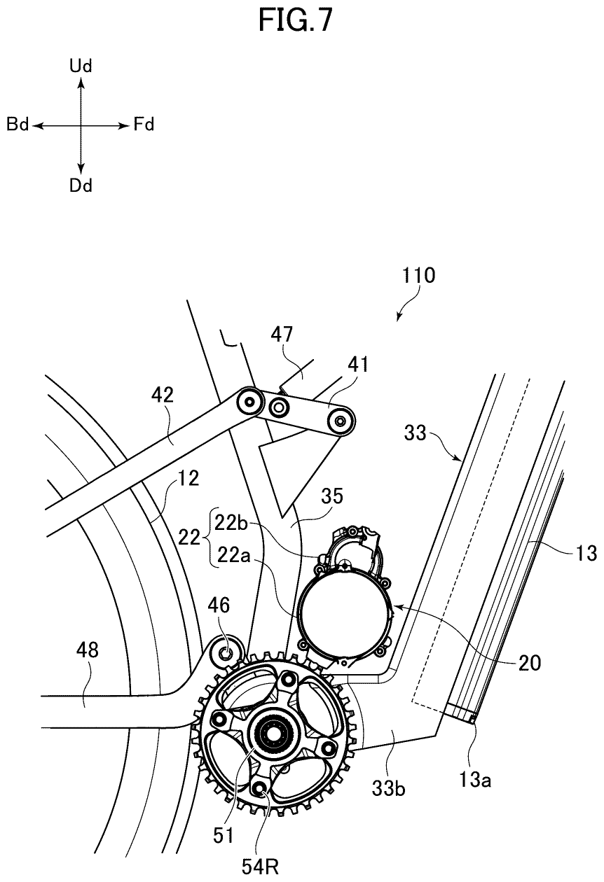

FIGS. 7 to 9 show an electric assist bicycle 110 according to a second example. In the following description, the differences between the electric assisted bicycle 10 shown in FIG. 1 and the like, and the electric assisted bicycle 110 will be mainly discussed. Matters that are not explained in the electric assisted bicycle 110 may be the same as in the electric assisted bicycle 10.

As shown in FIG. 7, the motor unit 20 is disposed behind the down frame portion 33 and in front of the seat frame portion 35 in the bicycle 110. With such an arrangement of the motor unit 20, the front side of the motor unit 20 can be protected by the down frame portion 33. The motor unit 20 is mounted on the down frame portion 33 and/or the seat frame portion 35 by a fastener, such as a screw and a bolt.

As shown in FIG. 7, the motor unit 20 is disposed above the frame bottom 32 and the lowermost part 33b of the down frame portion 33. With such an arrangement of the motor unit 20, the lowermost part 33b of the down frame portion 33 can protect the lower side of the motor unit 20 and prevent the minimum ground clearance of the bicycle 110 from being reduced due to the motor unit 20.

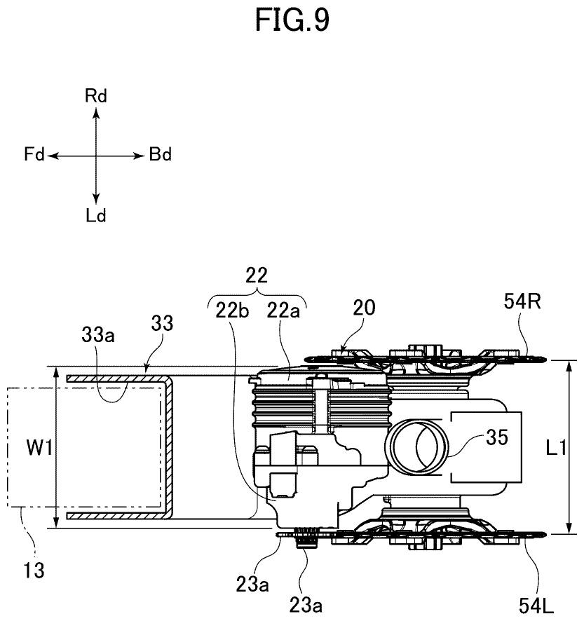

As shown in FIG. 9, the motor unit 20 is disposed between the right sprocket 54R and the left sprocket 54L in the plan view of the electric assisted bicycle 110. As shown in FIG. 7, the motor unit 20 may be positioned above the right sprocket 54R and the left sprocket 54L in the side view of the electric assist bicycle 110.

Unlike the example shown in FIG. 7, the motor unit 20 may overlap the sprockets 54R and 54L in the side view of the bicycle 110. In this manner, the motor unit 20 can be positioned closer to the crankshaft 52, and the moment of inertia about the crankshaft 52 can thereby be reduced. In this case, a recess may be formed on the upper side of the lowermost part 33b of the down frame portion 33, and a part of the motor unit 20 may be disposed in the recess.

As shown in FIG. 7, the motor unit 20 is positioned below the rear cushion 47. The motor unit 20 is positioned below the front part (more specifically, the first link member 41) of the link mechanism 40.

As shown in FIG. 8, the motor unit 20 may be positioned upright between the down frame portion 33 and the seat frame portion 35. That is, one of the central shaft 21a of the electric motor 21 and the motor output shaft 23 are located in the vertical direction from the other one of the central shaft 21a of the electric motor 21 and the motor output shaft 23. Such an arrangement of the motor unit 20 serves to reduce the distance L2 between the down frame portion 33 and the seat frame portion 35 in the front-rear direction.

As shown in FIG. 8, the width w1 of the motor unit 20 in the first direction is greater than the width w2 in the direction (second direction) perpendicular to the first direction. In this regard, the first direction is a direction in which the motor output shaft 23 is apart from the central shaft 21a of the electric motor 21. The motor unit 20 is disposed such that the first direction is substantially along the down frame portion 33 and the seat frame portion 35.

The motor unit 20 is disposed such that the electric motor 21 is positioned below the motor output shaft 23. In this layout, the center of gravity of the motor unit 20 can be positioned closer to the crankshaft 52 compared to the layout in which the electric motor 21 is positioned above the motor output shaft 23. As such, the moment of inertia of the bicycle 110 about the crankshaft 52 can be reduced, and thus the operability of the bicycle 10 can be thereby improved.

As shown in FIG. 8, the battery 13 is disposed in front of the down frame portion 33 as in the example of the bicycle 10. On the other hand, the motor unit 20 is disposed behind the down frame portion 33 as described above. In this layout of the battery 13 and the motor unit 20, the battery 13 and the motor unit 20 do not interfere, and thus the battery 13 can be positioned lower.

As shown in FIG. 8, the position of the lower end 13a of the battery 13 is lower than that of the motor unit 20. More specifically, the position of the lower end 13a of the battery 13 is lower than the lower end of the motor unit 20. Further, the position of the lower end 13a of the battery 13 is lower than the horizontal line H3 passing through the upper ends of the left and right sprockets 54L and 54R. Such an arrangement of the battery 13 serves to reduce the distance between the lowermost part of the battery 13 and the crankshaft 52, and the moment of inertia about the crankshaft 52 can be thereby reduced.

Similarly to the bicycle 10 shown in FIG. 1, the bicycle 110 may also include a tensioner 71 (see FIG. 3A) that pushes a part of the left chain 56L (a chain that transmits torque of the motor unit 20 to the crankshaft 52). The tensioner 71 may be supported by the body frame 30 (e.g., the down frame portion 33) or by the housing 22 of the motor unit 20.

### Third Example of Electric Assisted Bicycle

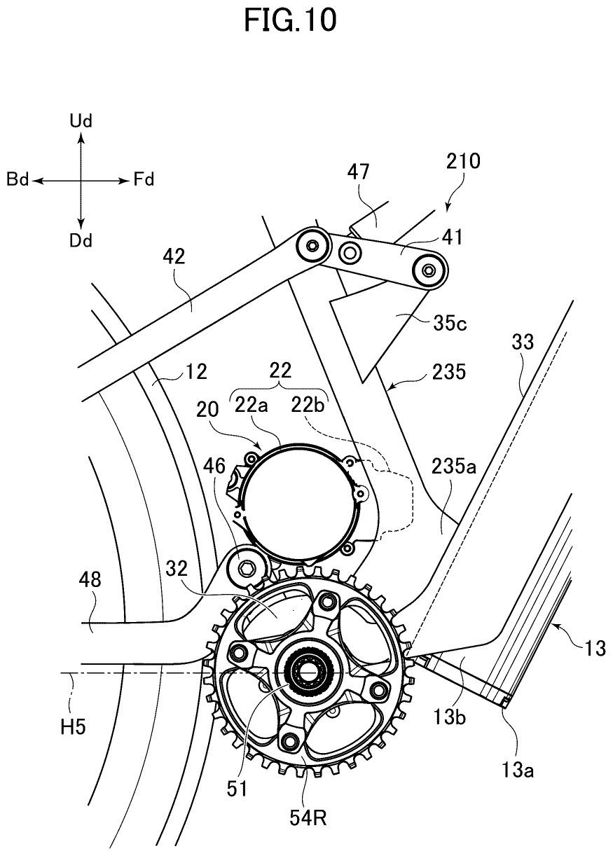

FIGS. 10 to 13 are diagrams illustrating an electric assist bicycle 210 according to a third example. In the following description, the differences between the electric assisted bicycle 10 shown in FIG. 1 and the like, and the electric assisted bicycle 210 will be mainly discussed. Matters that are not explained in the electric assisted bicycle 210 may be the same as in the electric assisted bicycle 10.

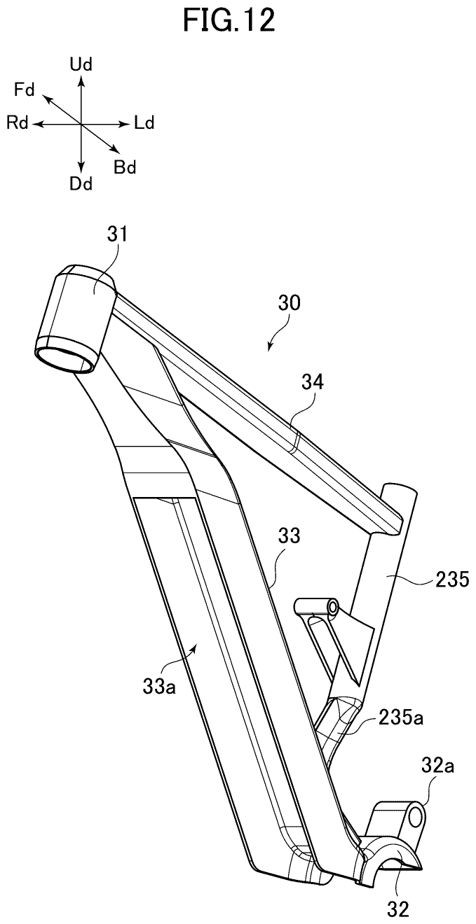

As shown in FIGS. 10 and 11, the motor unit 20 is positioned above the frame bottom 32 (see FIG. 12) in the bicycle 210. In other words, the motor unit 20 intersects the vertical line L3 passing through the crankshaft 52 in the side view of the bicycle 210. The motor unit 20 is positioned behind the seat frame portion 235.

As shown in FIG. 10, a lower part 235a of the seat frame portion 235 is connected to the upper side of the lowermost part 33b of the down frame portion 33. The seat frame portion 235 extends diagonally backward and upward from the lowermost part 33b. Such a frame structure forms a space above the frame bottom 32. The motor unit 20 is disposed in this space.

Such a layout of the motor unit 20 facilitates securing a space in front of the frame bottom 32, that is, in front of the bottom bracket 51. This space can be used to dispose the battery 13 supported by the down frame portion 33. More specifically, as shown in FIG. 10, the lowermost part 13b of the battery 13 is positioned in front of the bottom bracket 51. The lowermost part 13b of the battery 13 is positioned below the lower part 235a of the seat frame portion 235.

As shown in FIG. 10, the position of the lower end 13a of the battery 13 is lower than that of the motor unit 20. The position of the lower end 13a of the battery 13 is lower than a horizontal line H5 passing through the center of the crankshaft 52. This structure serves to reduce the distance between the battery 13 and the crankshaft 52 to reduce the moment of inertia about the crankshaft 52.

As shown in FIG. 11, one of the central shaft 21a of the electric motor 21 and the motor output shaft 23 are located in the front-rear direction from the other one of the electric motor 21 and the motor output shaft 23. In other words, a horizontal line H6 intersects both the central shaft 21a of the electric motor 21 and the motor output shaft 23. This structure serves to lower the center of gravity of the motor unit 20 compared to a case in which the motor unit 20 is positioned upright, for example.

The frame bottom 32 includes a support portion 32a (see FIG. 12), and the rear arm 48 is coupled to the support portion 32a via the pivot shaft 46. The motor unit 20 is disposed between the pivot shaft 46 and the seat frame portion 235. More specifically, the central shaft 21a of the electric motor 21 and the motor output shaft 23 are both positioned in front of the pivot shaft 46.

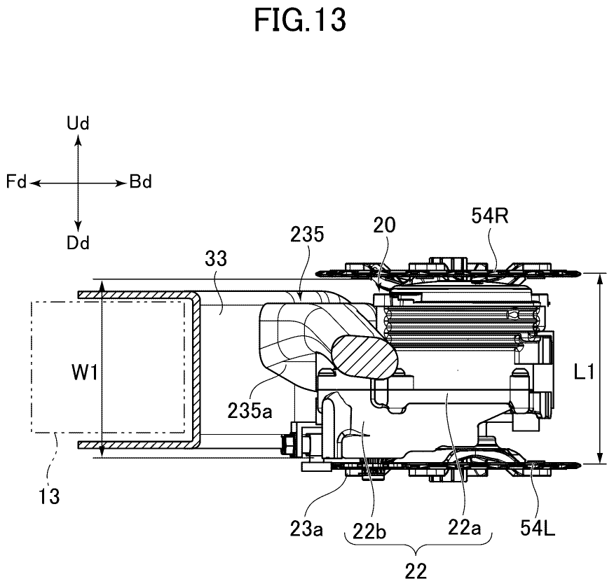

As described above, the motor unit 20 includes the main body 22a in which the electric motor 21 is disposed, and the protruding portion 22b including the reduction mechanism 24 (see FIG. 5) and the motor output shaft 23. As shown in FIG. 13, the protruding portion 22b extends forward from the left part of the main body 22a in the bicycle 210.

As shown in FIGS. 10 and 13, the main body 22a is positioned behind the seat frame portion 235. The lower part 235a of the seat frame portion 235 is shifted to the right with respect to the center of the bicycle 210 in the left and right direction. The protruding portion 22b of the motor unit 20 is positioned to the left of the lower part 235a of the seat frame portion 235 and overlaps the seat frame portion 235 in the side view of the bicycle 210. Such a frame structure and a layout of the motor unit 20 prevent excessive rearward position of the motor unit 20.

As shown in FIG. 11, the bicycle 210 also includes the tensioner 71 that pushes a part of the left chain 56L (chain that transmits torque of the motor unit 20 to the crankshaft 52). The tensioner 71 is supported by the body frame 30 (e.g., seat frame portion 235). Alternatively, the tensioner 71 may be supported by the housing 22 of the motor unit 20.

### Conclusion

(1) As described above, in the electric assisted bicycles 10, 110, and 210, the first sprocket 54L is disposed on the left side of the bottom bracket 51 and configured to integrally rotate with the crankshaft 52. The second sprocket 54R is disposed on the right side of the bottom bracket 51 and configured to integrally rotate with the crankshaft 52. The first chain 56L that transmits torque from the third sprocket 23a to the first sprocket 54L is wound around the outer periphery of the third sprocket 23a provided to the motor output shaft 23 and the outer periphery of the first sprocket 54L. The second chain 56R that transmits torque from the second sprocket 54R to the fourth sprocket 55a is wound around the outer periphery of the fourth sprocket 55a provided to the axle 12a of the rear wheel 12 and the outer periphery of the second sprocket 54R.

As described, in the electric assisted bicycles 10, 110, and 210, the torque of the motor unit 20 is transmitted to the crankshaft 52 through the first chain 56L, and the torque of the crankshaft 52 is transmitted to the axle 12a of the rear wheel 12 through the second chain 56R. As such, the flexibility in the position of the motor unit 20 can be increased compared to a structure in which the torque of the motor unit 20 is directly transmitted to the second chain 56R, for example. Further, the first chain 56L is disposed on the left side of the bottom bracket 51 and the second chain 56R is disposed on the right side of the bottom bracket 51, and thus interference between the first chain 56L and the second chain 56R can be easily avoided.
(2) In a plan view of the electric assisted bicycles 10, 110, and 210 according to (1), at least a part of the motor unit 20 is positioned between the first sprocket 54L and the second sprocket 54R. In this structure, the motor unit 20 can be positioned closer to the crankshaft 52. As the motor unit 20 is positioned closer to the crankshaft 52, the moment of inertia around the crankshaft 52 can be reduced to improve the operability of the bicycle.
(3) In a side view of the electric assisted bicycle 10 according to (2), a part of the motor unit 20 overlaps at least one of the first sprocket 54L or the second sprocket 54R. In this structure, the position of the motor unit 20 is close to the crankshaft 52. As such, the moment of inertia around the crankshaft 52 can be reduced to improve the operability of the bicycle.
(4) The electric assist bicycles 10, 110, and 210 according to any one of (1) to (3) further includes the body frame 30 that includes the head pipe 31 supporting the steering shaft 16, the down frame portion 33 extending diagonally backward and downward from the head pipe 31, and the frame bottom 32 supporting the bottom bracket 51.
(5) In the electric assisted bicycles 110 and 210 according to (4), the motor unit 20 is disposed above the frame bottom 32. Such a layout facilitates securing a space in front of the frame bottom 32. This space can be used to dispose other components (e.g. battery 13).
(6) In the electric assisted bicycle 110 according to (4) or (5), the motor unit 20 is disposed behind the down frame portion 33. In such a layout, the motor unit 20 can be protected by the down frame portion 33.
(7) In the electric assisted bicycles 110 and 210 according to any one of (4) to (6), the body frame 30 includes the seat frame portion 35 that is positioned behind the down frame portion 33, the motor unit 20 is disposed behind the seat frame portion 35, and a battery 13 is mounted on the down frame portion 33. Such a layout facilitates securing a space in front of the frame bottom 32. This space can be used to dispose the battery 13.
(8) In the electric assisted bicycle 10 according to any one of (4) to (7), the recess 33d is formed in the body frame 30 and a part of the motor unit 20 is disposed in the recess 33d. This structure can further increase the flexibility in the position of the motor unit 20.
(9) In the electric assisted bicycle 10 according to (8), the motor unit 20 is disposed below the body frame 30 and the recess 33d that opens downward is formed in the body frame 30. This structure prevents the motor unit 20 from being positioned excessively low.
(10) In the electric assisted bicycle 10 according to any one of (1) to (9), the motor unit 20 is positioned in front of the bottom bracket 51, and one of the central shaft 21a of the electric motor 21 and the motor output shaft 23 are located in a front-rear direction from the other one of the central shaft 21a of the electric motor 21 and the motor output shaft 23. Such an arrangement of the motor unit 20 can prevent, for example, the center of gravity of the motor unit 20 from being excessively low.
(11) In the electric assisted bicycle 110 according to any one of (1) to (9), the motor unit 20 is disposed above the bottom bracket 51, and the central shaft 21a of the electric motor 21 is positioned lower than the motor output shaft 23. With this arrangement, the center of gravity of the motor unit 20 can be lowered and positioned closer to the crankshaft 52 compared to a structure in which the central shaft 21a of the electric motor 21 is positioned higher than the motor output shaft 23, for example.
(12) The electric assisted bicycles 10, 110, and 210 according to (4) further includes the battery 13 that supplies a current to the motor unit 20, and the battery 13 is disposed in the front side of the down frame portion 33. With the arrangement of (12), the relatively large space in front of the down frame portion 33 can be used to easily dispose the battery 13 with a large capacity. For example, an elongate battery 13 may be disposed in the extending direction of the down frame portion 33.
(13) In the electric assisted bicycles 10, 110, and 210 according to (12), the lower end 13a of the battery 13 is positioned lower than the upper end of at least one of the first sprocket 54L or the second sprocket 54R. Such an arrangement serves to lower the center of gravity of the battery 13.
(14) In the electric assisted bicycles 110 and 210 according to (12), the lower end 13a of the battery 13 is positioned lower than the motor unit 20. Such an arrangement serves to lower the center of gravity of the battery 13.
(15) The electric assisted bicycles 10, 110, and 210 according to any one of (1) to (14) further include a tensioner 71 that pushes the first chain 56L toward the outside or the inside of the first chain 56L. Such a structure can reduce the shaking of the first chain 56L while the bicycle is traveling and prevent disengagement between the first chain 56L and the first and third sprockets 23a.
(16) The electric assist bicycles 10, 110, and 210 according to (15) further includes the body frame 30 that includes the head pipe 31 supporting the steering shaft 16, the down frame portion 33 extending diagonally backward and downward from the head pipe 31, and the frame bottom 32 supporting the bottom bracket 51. The tensioner 71 is supported by the body frame 30. Such a structure serves to easily select the position of the tensioner 71.
(17) In the electric assisted bicycles 10, 110, and 210 according to (15), the tensioner 71 is supported by the housing 22 of the electric motor 21.

### Others

The electric assisted bicycle proposed in the present disclosure is not limited to the electric assisted bicycles 10, 110, and 210 described above.

For example, in the bicycles 10, 110, and 210, a sprocket is used as a rotating member to transmit torque, and a chain is used as an annular transmission member to transmit torque. In this regard, a pulley may be used as the rotating member, and a belt may be used as the annular transmission member.

For example, a chain may be used as the annular transmission member that transmits the torque of the motor unit 20 to the crankshaft 52, and a belt may be used as the annular transmission member that transmits the torque of the crankshaft 52 to the rear wheel 12. Conversely, a belt may be used as the annular transmission member that transmits the torque of the motor unit 20 to the crankshaft 52, and a chain may be used as the annular transmission member that transmits the torque of the crankshaft 52 to the rear wheel 12.

The arrangement of the two chains 56L and 56R may be reversed. That is, the chain that transmits the torque of the motor unit 20 to the crankshaft 52 may be disposed on the right side of the bicycle, and the chain that transmits the torque of the crankshaft 52 to the rear wheel 12 may be disposed on the left side of the bicycle.

The bicycles 10, 110, and 210 are motocross-type bicycles designed for traveling on rough terrain. However, the structure proposed in the present disclosure may be applied to a bicycle traveling on a street. In this case, the electric assisted bicycle may not include the rear cushion 47 and the main frame portion 34, for example.

Although the present invention has been illustrated and described herein with reference to embodiments and specific examples thereof, it will be readily apparent to those of ordinary skill in the art that other embodiments and examples may perform similar functions and/or achieve like results. All such equivalent embodiments and examples are within the spirit and scope of the present invention, are contemplated thereby, and are intended to be covered by the following claims.

What is claimed is:

1. An electric assisted bicycle comprising:
a crankshaft;
a bottom bracket that supports the crankshaft;
a motor unit that includes an electric motor, a housing that houses the electric motor, and a motor output shaft that outputs torque of the electric motor, the motor unit being separated from the bottom bracket;
a first rotating member that is disposed on one of a right side or a left side of the bottom bracket and configured to rotate integrally with the crankshaft;
a second rotating member that is disposed on the other one of the right side or the left side of the bottom bracket and configured to rotate integrally with the crankshaft;
a third rotating member that is provided to the motor output shaft;
a first annular transmission member that is wound around an outer periphery of the first rotating member and an outer periphery of the third rotating member and transmits torque from the third rotating member to the first rotating member;
a fourth rotating member that is provided to an axle of a rear wheel; and
a second annular transmission member that is wound around an outer periphery of the second rotating member and an outer periphery of the fourth rotating member and transmits torque from the second rotating member to the fourth rotating member.

2. The electric assisted bicycle according to claim 1, wherein
at least a part of the motor unit is positioned between the first rotating member and the second rotating member in a plane view of the electric assisted bicycle.

3. The electric assisted bicycle according to claim 2, wherein
the part of the motor unit overlaps at least one of the first rotating member or the second rotating member in a side view of the electric assisted bicycle.

4. The electric assisted bicycle according to claim 1, further comprising a body frame that includes a head pipe supporting a steering shaft, a down frame portion extending diagonally backward and downward from the head pipe, and a frame bottom supporting the bottom bracket.

5. The electric assisted bicycle according to claim 4, wherein
the motor unit is disposed above the frame bottom.

6. The electric assisted bicycle according to claim 4, wherein
the motor unit is disposed behind the down frame portion.

7. The electric assisted bicycle according to claim 4, wherein
the body frame includes a seat frame portion that is positioned behind the down frame portion,
the motor unit is disposed behind the seat frame portion, and
a battery is attached to the down frame portion.

8. The electric assisted bicycle according to claim 4, wherein
a recess is formed in the body frame, and
a part of the motor unit is disposed in the recess.

9. The electric assisted bicycle according to claim 8, wherein
the motor unit is disposed below the body frame, and
the recess that opens downward is formed in the body frame.

10. The electric assisted bicycle according to claim 1, wherein
the motor unit is positioned in front of the bottom bracket, and
one of a central shaft of the electric motor and the motor output shaft is located in a front-rear direction from the other one of the central shaft of the electric motor and the motor output shaft.

11. The electric assisted bicycle according to claim 1, wherein
the motor unit is disposed above the bottom bracket, and
a central shaft of the electric motor is positioned lower than the motor output shaft.

12. The electric assisted bicycle according to claim 4, further comprising a battery that supplies a current to the motor unit, wherein
the battery is disposed in a front side of the down frame portion.

13. The electric assisted bicycle according to claim 12, wherein
a lower end of the battery is positioned lower than an upper end of at least one of the first rotating member or the second rotating member.

14. The electric assisted bicycle according to claim 12, wherein
the lower end of the battery is positioned lower than the motor unit.

15. The electric assisted bicycle according to claim 1, further comprising a tensioner that pushes a part of the first annular transmission member toward an outside or an inside of the first annular transmission member.

16. The electric assisted bicycle according to claim 15, further comprising a body frame that includes a head pipe supporting a steering shaft, a down frame portion extending diagonally backward and downward from the head pipe, and a frame bottom supporting the bottom bracket, wherein
the tensioner is supported by the body frame.

17. The electric assisted bicycle according to claim 15, wherein
the tensioner is supported by the housing of the electric motor.
